(19) United States
(12) Patent Application Publication
(10) Pub. No.: US 2014/0122254 A1
(43) Pub. Date: May 1, 2014

(54) COMPOSITE BIDDING SYSTEM

(71) Applicants: John Sloboda, Zurich (CH); Hannu Helminen, Zurich (CH)

(72) Inventors: John Sloboda, Zurich (CH); Hannu Helminen, Zurich (CH)

(21) Appl. No.: 13/666,688

(22) Filed: Nov. 1, 2012

(51) Int. Cl. G06Q 30/02

(52) U.S. Cl. 705/14.71

(57) ABSTRACT

Systems, methods, and computer-readable storage media that may be used to allow composite bidding in auctions are provided. One method includes receiving a plurality of initial bids. Each initial bid includes a bid amount for a content item to be displayed. The method further includes receiving one or more supplemental bids. Each of the supplemental bids is associated with one or more of the plurality of initial bids and comprises a supplemental amount. The method further includes determining, for each of the initial bids, a combined bid amount based on the bid amount of the initial bid and the supplemental amount of any supplemental bids associated with the initial bid. The method further includes determining one or more of the plurality of initial bids to win the auction based on the combined bid amounts.

### BACKGROUND

Online auctions are often used to select content to be displayed in resources such as websites. In such auctions, third parties (i.e., parties other than the owner/creator of the resource) submit bids to have their content appear in resources, such as search results pages for search queries relating to their business or products/services and/or resources having a subject matter that relates to their business. Online auctions allow a single party to submit a bid for a content item to be displayed. Other parties cannot directly contribute to the bid.

### SUMMARY

One implementation of the disclosure relates to a method that includes receiving, at a computerized auction system, a plurality of initial bids. Each initial bid includes a bid amount for a content item to be displayed. The method further includes receiving, at the auction system, one or more supplemental bids. Each of the supplemental bids is associated with one or more of the plurality of initial bids and comprises a supplemental amount. The method further includes determining, at the auction system, for each of the initial bids, a combined bid amount based on the bid amount of the initial bid and the supplemental amount of any supplemental bids associated with the initial bid. The method further includes determining, at the auction system, one or more of the plurality of initial bids to win the auction based on the combined bid amounts. The plurality of initial bids are received from one or more auctions participants, and the one or more supplemental bids are received from one or more supplementing parties. For each supplemental bid, the supplementing party from whom the supplemental bid is received is a different party than the auction participant from whom the initial bid with which the supplemental bid is associated is received.

Another implementation of the disclosure relates to a system including at least one computing device operably coupled to at least one memory and configured to receive a plurality of initial bids. Each initial bid includes a bid amount for a content item to be displayed. The at least one computing device is further configured to receive one or more supplemental bids. Each of the supplemental bids is associated with one or more of the plurality of initial bids and comprises a supplemental amount. The at least one computing device is further configured to determine, for each of the initial bids, a combined bid amount based on the bid amount of the initial bid and the supplemental amount of any supplemental bids associated with the initial bid. The at least one computing device is further configured to determine one or more of the plurality of initial bids to win the auction based on the combined bid amounts. The plurality of initial bids are received from one or more auctions participants, and the one or more supplemental bids are received from one or more supplementing parties. For each supplemental bid, the supplementing party from whom the supplemental bid is received is a different party than the auction participant from whom the initial bid with which the supplemental bid is associated is received.

Another implementation of the disclosure relates to a computer-readable storage medium having instructions stored thereon that, when executed by a processor, cause the processor to perform operations including receiving a plurality of initial bids. Each initial bid includes a bid amount for a content item to be displayed. The operations further include receiving one or more supplemental bids. Each of the supplemental bids is associated with one or more of the plurality of initial bids and comprises a supplemental amount. The operations further include determining, for each of the initial bids, a combined bid amount based on the bid amount of the initial bid and the supplemental amount of any supplemental bids associated with the initial bid. The operations further include determining one or more of the plurality of initial bids to win the auction based on the combined bid amounts. The plurality of initial bids are received from one or more auctions participants, and the one or more supplemental bids are received from one or more supplementing parties. For each supplemental bid, the supplementing party from whom the supplemental bid is received is a different party than the auction participant from whom the initial bid with which the supplemental bid is associated is received.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an auction system and associated environment according to an illustrative implementation.

FIG. 2 is a flow diagram of a process that allows composite bidding according to an illustrative implementation.

FIG. 3 is a flow diagram of process for receiving a supplemental bid according to another illustrative implementation.

FIGS. 4 and 5 are display images of an interface that third parties may use to apply supplemental bids in an online auction according to illustrative implementations.

FIG. 6 is an example display image of an interface that an auction participant may use to provide settings relating to how boosters can contribute to a content campaign according to an illustrative implementation.

FIG. 7 is a block diagram of an example computing system according to an illustrative implementation.

### DETAILED DESCRIPTION

Referring generally to the Figures, various illustrative systems and methods are provided that may be used to allow composite bidding in auctions to display content on online resources. Some such resources may include, for example, websites or webpages, online social networking communities, network-enabled applications, etc. Initial bids to display content may be received by an auction system. Supplemental bids may then be received that may be used to boost or supplement one or more of the initial bids to increase the likelihood that those initial bids will win and the content associated with the initial bids will be displayed. In some implementations, a boosting party (i.e., a party that submits a supplemental bid) may be a third party that has no particular relationship with the party or parties who submitted the initial bids. The auction system may provide an interface allowing the boosting party to filter the initial bids in the auction based on various criteria, such as keywords associated with the bid content. In some embodiments, the auction system may present the boosting party with information about the filter results, such as how many initial bids satisfied the filter criteria, but may not allow the boosting party to view the individual content items. This may help to maintain the confidentiality of the content items submitted to the auction system and the parties who submitted the initial bids while still allowing interested third parties to contribute to the outcome of the auction. Various other filtering and privacy-related techniques may be utilized to give boosting parties the ability to target the content to which they wish to contribute while still maintaining the confidentiality of the information submitted to the auction system.

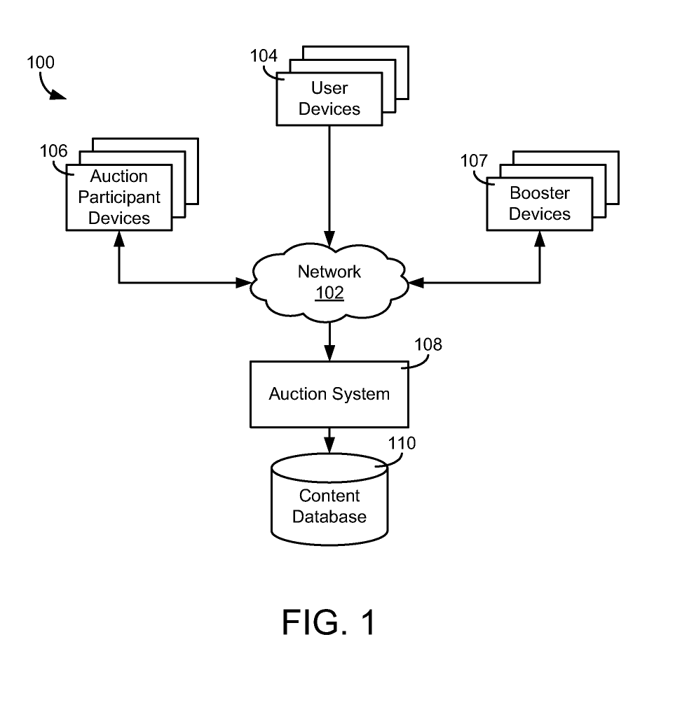

Referring now to FIG. 1, and in brief overview, a block diagram of an auction system 108 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. Auction system 108 may be configured to select content for display to users within resources (e.g., webpages, applications, etc.) and to provide content from a content database 110 to user devices 104 over network 102 for display within the resources. Bids for content to be selected by auction system 108 may be provided to auction system 108 from auction participants using auction participant devices 106 configured to communicate with auction system 108 through network 102. Auction system 108 is configured to receive supplemental bids through network 102 from booster devices 107 operated by parties who wish to supplement the initial bids in an effort to help the initial bids win the auction.

Referring still to FIG. 1, and in greater detail, user devices 104 may be any type of computing device (e.g., having a processor and memory or other type of computer-readable medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 may be designed to use various types of software and/or operating systems. In various illustrative implementations, user devices 104 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 may be configured to receive data from various sources using a network 102. In some implementations, network 102 may comprise a computing network (e.g., LAN, WAN, Internet, etc.) to which user devices 104 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Some content that may be accessed via user devices 104 may include content that has been selected to appear in conjunction with certain resources through an auction process. For example, a portion of a search result interface or another resource may be configured to display content that has been selected through the use of an auction. An auction system 108 may be configured to receive bids from auction participants and select content to be displayed in resources (e.g., on webpages) based on the bids. In some implementations, content may be ranked based on bids associated with the content. A search engine or other resource operator may receive revenue by auctioning a certain set of keywords to auction participants. Auction participants may place auction bids for the ability to include their content on the search result resource, whenever a user searches using a keyword in the set. For example, an online retailer of golf equipment may participate in an auction for the golf-related set of keywords. If a user searches for the term “golf,” and the retailer is determined to be the winner of the auction, content from the retailer may appear in the same resource as the search results. A provider of a website devoted to a particular topic may also receive revenue by auctioning off the ability to place content with his or her resource (e.g., embedded in a webpage, in a pop-up window, etc.). In some implementations, the provider of the website may be a different entity than the provider of auction system 108. Similar to bidding on search results, an auction participant may place a bid in the auction using a set of keywords that corresponds to keywords found in the text of the resource. In some embodiments, the auction bids may additionally or alternatively include targeting criteria other than keywords, such as user interests, locations (e.g., geographic areas), semantic entities of resources (e.g., web pages), etc.

In one implementation, an auction participant or other party may create an account with auction system 108. Associated with the account may be data relating to which content the auction participant wishes to use, a daily budget to spend, topical categories of resources on which the content is to be placed (e.g., resources related to Sports>Golf, etc.), one or more bid amounts, or other data that may be used by auction system 108 to select advertisements or other content to be displayed by user devices 104. When a user device 104 interacts with a resource that participates in the auction network, auction system 108 may compare bids among auction participants to select content to be included in the resource. In some implementations, bids may be received from auction participant devices 106, and information relating to the bids, including the content associated with the bids, may be stored in a content database 110. Auction participant devices 106 may be similar devices and/or have similar characteristics and features as described with respect to user devices 104.

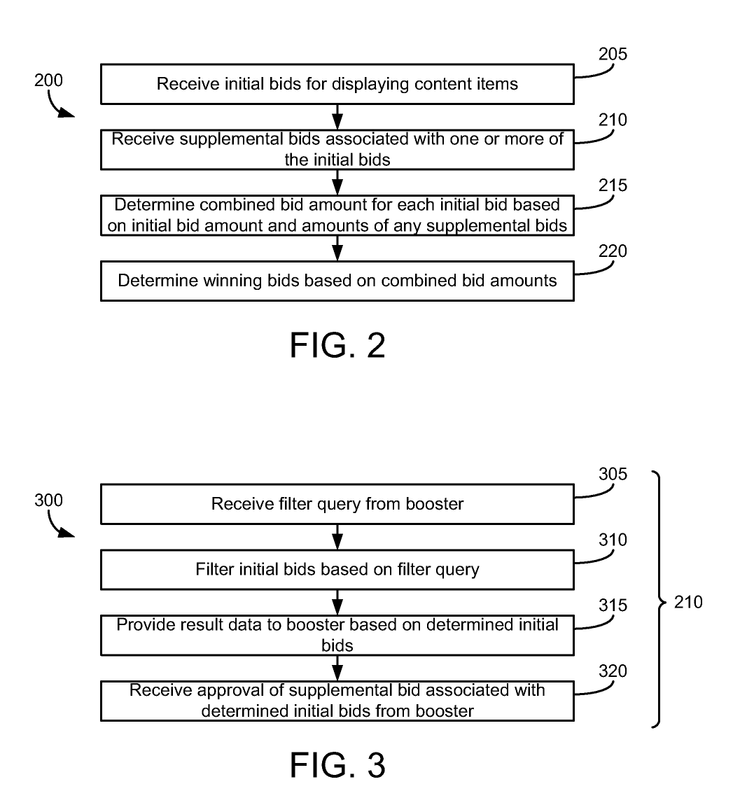

Auction system 108 is configured to allow initial bids submitted to auction system 108 to be “boosted,” or supplemented, to increase the likelihood that the supplemented initial bids will win the auction and the associated content will be selected for publishing in one or more resources. FIG. 2 illustrates a flow diagram of a process 200 that allows composite bidding according to an illustrative implementation. Referring to both FIGS. 1 and 2, initial bids may be received by auction system 108 from auction participant devices 106 (205). The initial bids may include content that the auction participants wish to have displayed or published and an initial bid amount that the auction participant is willing to pay for the content being displayed.

Auction system 108 is configured to receive one or more supplemental bids from boosters who wish to increase the likelihood that initial bids meeting certain criteria will win the auction (210). The boosters, or supplementing parties, may provide supplemental bids via booster devices 107 that communicate with auction system 108 through network 102. In some implementations, booster devices 107 may be similar devices and/or have similar characteristics and features as described with respect to user devices 104. In some implementations, the boosting parties that submit supplemental bids to supplement initial bids in the auction may be different parties without any particular relationship with the parties from whom the initial bids were received.

Supplemental bids may be submitted by various parties for various types of purposes and/or applications. For example, a manufacturer of a product may be interested in submitting supplemental bids to boost bids that feature the manufacturer's product. This may help increase the visibility of the manufacturer's product to consumers. In another example, one or more initial bids may be associated with public service or charitable content promoting certain causes, such as content soliciting donations to support research for prevention of a particular disease, content educating the public about a public health risk, etc. In some implementations, auction system 108 may provide a method for auction participants with little financial resources to generate content and allow other parties with greater financial resources to fund the content campaign.

In some implementations, auction system 108 may be configured to present boosters with a boosting interface on booster devices 107 that may be used to identify and select supplemental bids to apply in the auction. The interface may provide a booster with the ability to filter the initial bids in an auction based on one or more terms and/or based on a filter query including one or more terms.

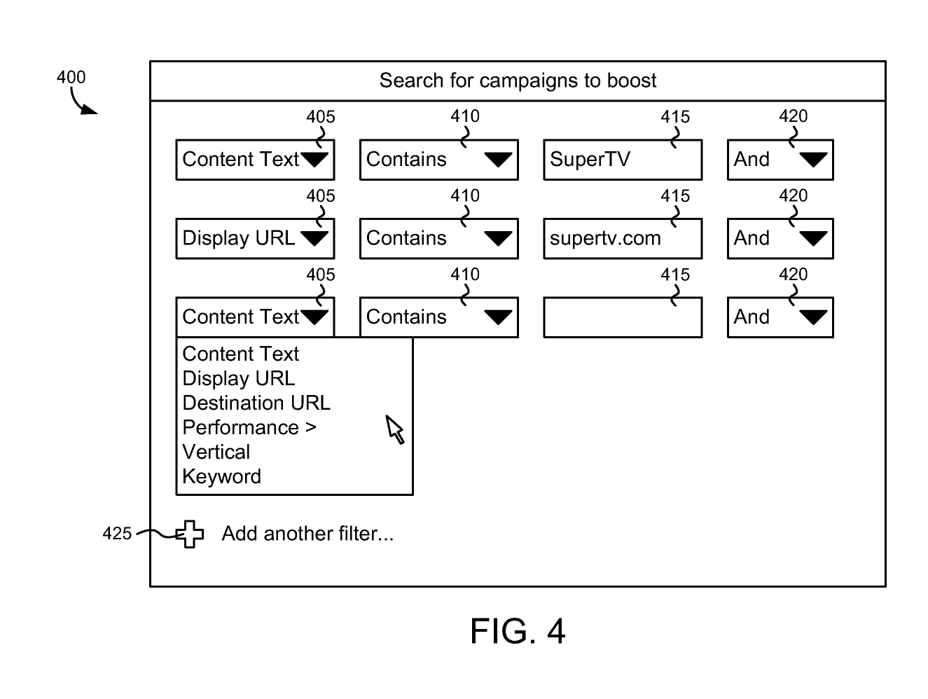

FIG. 3 illustrates a flow diagram of a process 300 for receiving a supplemental bid (e.g., step 210 of process 200) according to an illustrative implementation. Referring now to FIGS. 1 and 3, auction system 108 may be configured to receive a filter query from a booster device 107 via network 102 (305). The filter query may include one or more terms to be used in identifying relevant initial bids to possibly be supplemented.

Auction system 108 is configured to filter through the initial bids based on the terms to identify initial bids associated with the filter query (310). Auction system 108 may be configured to identify relevant initial bids based on comparison of the terms to text in the content associated with the initial bids, text in the online address (e.g., URL) of a displaying resource upon which the content would be displayed and/or a landing resource to which the content links when selected on the displaying resource, text appearing in the displaying resource and/or landing resource, targeting keywords associated with the bid content, etc. In some implementations, auction system 108 may be configured to crawl (e.g., search) the content of the displaying resource and/or the landing resource and extract terms associated with the resources. This crawling activity may be performed when the content is provided to auction system 108 or sometime after the content is provided. In some implementations, other filtering methods may be utilized to identify relevant content, such as extracting text from an image included in the bid content using character recognition methods and/or comparing an image (e.g., a logo) provided by the booster to images included in the bid content to determine whether the provided image appears in any of the bid content.

Auction system 108 may filter the initial bids based on the terms provided by the booster and provide the booster with results for the booster to review prior to committing to applying a supplemental bid (315). In some implementations, the results may be configured to provide the booster with information about the number and/or type of initial bids to which the supplemental bid would be applied without revealing a substantial amount of information about the content items themselves and/or without revealing the identity of the auction participants. For example, auction system 108 may provide a booster with a number of bids that were identified as being relevant to and/or including the terms provided by the booster. Auction system 108 may provide a booster with some example content items from identified bids that would be supplemented under the provided terms, provided the auction participants who submitted the content items have indicated that the items may be viewed by boosters (e.g., in general or only as part of a random sampling of identified initial bids). In some implementations, other information may be provided within the results, such as an average and/or median bid amount associated with the identified initial bids. In some implementations, the information used to filter the initial bids using the provided terms and/or the information provided within the results may be restricted to only information that may be used to target the bid content when auction system 108 is determining which content to display in a particular resource, such as a search result resource (e.g., a set of terms provided by the auction participant as being relevant to the content item and desired for use in targeting the content item).

Auction system 108 may present the booster with one or more options for supplementing the initial bid. For example, auction system 108 may allow a booster to supplement a bid by adding a set value or amount to the initial bid amount (e.g., add $5.00 to each identified bid amount). In another example, auction system 108 may allow a booster to supplement a bid by multiplying each initial bid amount by a particular value (e.g., multiply each identified bid amount by 1.5 times the original bid amount, such that a $10 initial bid amount would be boosted to a combined bid amount of $15.00). In yet another example, auction system 108 may allow a booster to supplement a bid by identifying a combined bid amount to which the booster wishes to boost each of the identified initial bids, where the booster may provide a supplemental bid amount equal to the difference between the provided combined bid amount and the initial bid amount. For example, if an identified initial bid amount is $5.00 and the booster provides a supplemental bid to boost the combined bid amount to $8.50, then the booster may commit to providing a supplemental bid amount of $3.50 for that particular initial bid. In other illustrative implementations, other boosting functions or methods may be provided to the booster to enable the booster to supplement one or more initial bids.

In some implementations, auction system 108 may provide the booster with information regarding the supplemental bid before and/or after the booster submits the supplemental bid, such as aggregated information regarding how much total cost the booster would be committing if the supplemental bid is submitted, the average/median boost value for the identified initial bids, etc. Once the booster is satisfied with the supplemental bid(s) that has been selected, the booster may submit approval of the supplemental bids to auction system 108 (320).

Referring again to FIGS. 1 and 2, once the booster has approved and submitted the supplemental bids, auction system 108 is configured to determine a combined bid amount for each initial bid based on the initial bid amount and the amounts of any supplemental bids applied to the initial bid (215). The combined bid amount is based on the type of supplemental bid received. For example, if an initial bid amount is $5.00 and a additive supplemental bid of $2.00 is received, the combined bid amount may be $7.00. In another example, if an initial bid amount is $5.00 and a multiplicative supplemental bid is 1.5× the initial bid, the combined bid amount may be $7.50. In some implementations, multiple supplemental bids of different types may be permitted for a single initial bid. For example, an initial bid having an amount of $5.00 may receive a multiplicative supplemental bid of 1.5× and an additive supplemental bid of $2.00, and the combined bid amount may be $9.50 (i.e., ($5.00×1.5)+$2.00). The combined bid amounts may be used to determine which bid(s) win the auction (e.g., by selecting the bid or bids having the highest combined bid amount) (220).

Once the auction has closed and one or more winning bids have been selected, auction system 108 may be configured to determine, for each winning bid, an amount to be paid by the auction participant who submitted the bid and any boosters who supplemented the bid. In some implementations, the price associated with a winning bid may be the combined bid amount of the winning bid, and each initial bidder and booster may be responsible for paying the amount of their respective initial bids and supplemental bids. For example, if a winning bid has a combined bid amount of $9.00, with the initial bidder submitted a bid amount of $5.00 and two boosters each submitting a supplemental bid in the amount of $2.00, then the initial bidder may be charged $5.00 and each of the boosters may be charged $2.00. In some implementations, the amount for which each contributor to a winning bid is responsible for paying may be determined based on a ratio of the contributor's bid amount to the total bid. For example, in a second price auction in which the price to be paid for a winning bid is the bid amount of the second highest bid, each contributor to the winning bid may be responsible for paying an amount equal to the second highest bid amount times the ratio of the contributor's bid amount to the combined winning bid amount, as follows:

Price_{Contributor}=Price_{Second Highest Bid}×(Bid_{Contributor}/Bid_{Combined})

In one example second price auction, an initial bidder may submit a bid amount of $10.00, a booster may submit a bid amount of $2.00, and a second highest bid may have a combined bid amount of $8.00. In one illustrative implementation of this example, the price paid by the initial bidder and the booster may be calculated as follows:

Price_{Initial Bidder}=$8.00×($10.00/$12.00)=$6.67

Price_{Booster}=$8.00×($2.00/$12.00)=$1.33

In still further illustrative implementations, final contributions to a final price to be paid for a winning bid may be determined in accordance with other methods. For example, in another implementation in a second price auction, an initial bidder may be responsible for at least the initial bid amount of a winning bid regardless of whether or not boosters contributed to the bid. Using such an implementation in the example provided in the above paragraph, the initial bidder may be responsible for the full $8.00 losing bid amount, because the $8.00 is less than the $10.00 bid amount the initial bidder originally pledged. In another example, the initial bid amount may be $10.00, the supplemental bid amount may be $2.00 (leading to a combined bid amount of $12.00), and the second highest bid amount may be $11.00. In this example, the initial bidder may be responsible for paying the $10.00 initial bid amount and the booster may be responsible for the $1.00 difference between the winning initial bid amount and the second highest bid amount.

In some embodiments, auction system 108 may provide an iterative auction process in which multiple consecutive rounds of bidding are allowed. In some implementations, auction system 108 may allow boosters to provide contributions at one or more of the rounds of bidding. For example, auction system 108 may allow boosters to submit a contribution manually in one or more of the rounds or may allow boosters to submit a schedule of boosts to be applied in different rounds. In one example, a booster may submit a supplemental bid specifying that a boost of $2.00 should be applied in a first bidding round, a boost of $4.00 may be applied in a second bidding round, a boost of $5.00 should be applied in a third bidding round, etc.

In some implementations, boosters may be provided with features that may be used to ensure that they are boosting the bids they wish to boost without disclosing a substantial amount of information to the boosters. For example, in some implementations, boosters may be allowed to specify negative filters to ensure that the content that is boosted is not content the booster does not wish to boost, such as content from a competitor or content that the booster does not wish to promote. The negative filters may allow the boosters to specify terms that the boosters do not want matched in identified bids and/or auction participants whose bids the boosters do not wish to boost. In some implementations, auction system 108 may provide previews of some content that is included in the identified initial bids to be boosted (e.g., with consent of the auction participants who submitted the initial bids). In some implementations, auction system 108 may be configured to provide boosters with an aggregated report (e.g., periodically) providing information about the bids that were supplemented by the booster (e.g., other words that co-occurred in the boosted content, trends about the content and/or initial bidders boosted, etc.). By aggregating the information, auction system 108 may preserve the confidentiality of the initial bidders and/or the bid content.

In some implementations, auction system 108 may be configured to provide proactive suggestions for supplemental bids that a booster may wish to submit rather than or in addition to manually set supplemental bids provided by the booster. Auction system 108 may suggest one or more supplemental bids based on certain terms auction system 108 has determined to be relevant to the booster and/or a product/service of the booster (e.g., based on a booster company name and/or brand of products/services). In some implementations, auction system 108 may provide some result data indicating a result associated with submitting the suggested supplemental bids, such as a number of initial bids that would be boosted under the suggested supplemental bid.

In some implementations, auction system 108 may be configured to permit auction participants to submit bids for content to be displayed without offering a bid amount (e.g., with a bid amount of zero). In such implementations, an auction participant may provide the content and allow other parties to fund the bid through supplemental bids. The combined bid amount for the content would include only the combined bid amounts of the supplemental bids as the initial bid amount is zero.

In some implementations, auction system 108 may be configured to select multiple winning bids in an auction. For example, auctions may occur at a block level. The block is a unit that contains multiple slots for individual content items. Typically, the top slots within a block are considered the best, as they receive most attention from the readers. An auction process determines the outcome of the block. In some implementations, not only can an block contain more than one content item (thus more than one winner), but it can take on different configurations, and the number of content items needed to fill the block may be determined by which configuration is selected. Once the configuration is selected, the number of winners may be determined by the number of content items required, and the winners may be assigned the most preferable content item slots based on the order in which they ranked. For example, consider bids in an auction ranking as follows in a second price auction: item1=$5, item2=$4, item3=$3, item4=$2, and item5=$1. If there are three winners, item1 may pay $4 (the price of the next highest bid of item2) and show in the best slot, item2 will pay $3 (the price of the next highest bid of item3) and show in the second best slot, item3 will pay $3 (the price of the next highest bid of item4) and shown in the remaining slot, and item4 and item5 will pay nothing and not show. The combined bid amounts used to determine the rankings may be based on a combination of the initial bid amounts and any supplemental bid amounts for the items. In some implementations, auction system 108 may be configured to provide a composite bidding process in the context of a content exchange. Content exchanges facilitate a market with participants offering placements in which to show content (publishers) and participants offering content to be shown (content providers/auction participants). When a publisher offers a placement, the content exchange makes a request to the content providers with the details of the placement, and the content providers each respond with an offer of content. The content exchange then selects the most preferable offer and facilitates showing the selected offer on that placement. Content exchanges can also participate in other content exchanges on behalf of their publishers and content providers.

In some implementations of composite bidding auction provided by auction system 108, the content exchange would take the place of a user device, requesting a set of content items from auction system 108 and specifying the constraints those content items must satisfy. With respect to the content exchange, auction system 108 would participate as a content provider. The content exchange may receive a request for content items, either from a direct client publisher intending to show the content items or from another content exchange. The content exchange may then make a request for content items that satisfy this request from its content providers, of which auction system 108 may is one, which may be either content networks supplying content/creatives or other content exchanges. Upon receiving the request from the content exchange, auction system 108 may run an auction between candidates (e.g., bids submitted to auction system 108) that satisfy the constraints for qualifying content items, using the combined initial and supplemental bids associated with the candidates to determine the winners. Auction system 108 then returns the set of winning candidates to the content exchange. After the deadline for candidate submissions, the content exchange examines the candidates it has received from the different content providers and decides a winner. The content exchange may inform auction system 108 of the result of the decision, including whether or not any of the content item candidates supplied by auction system 108 were successfully sold (e.g., were identified as winners in the decision process of the content exchange).

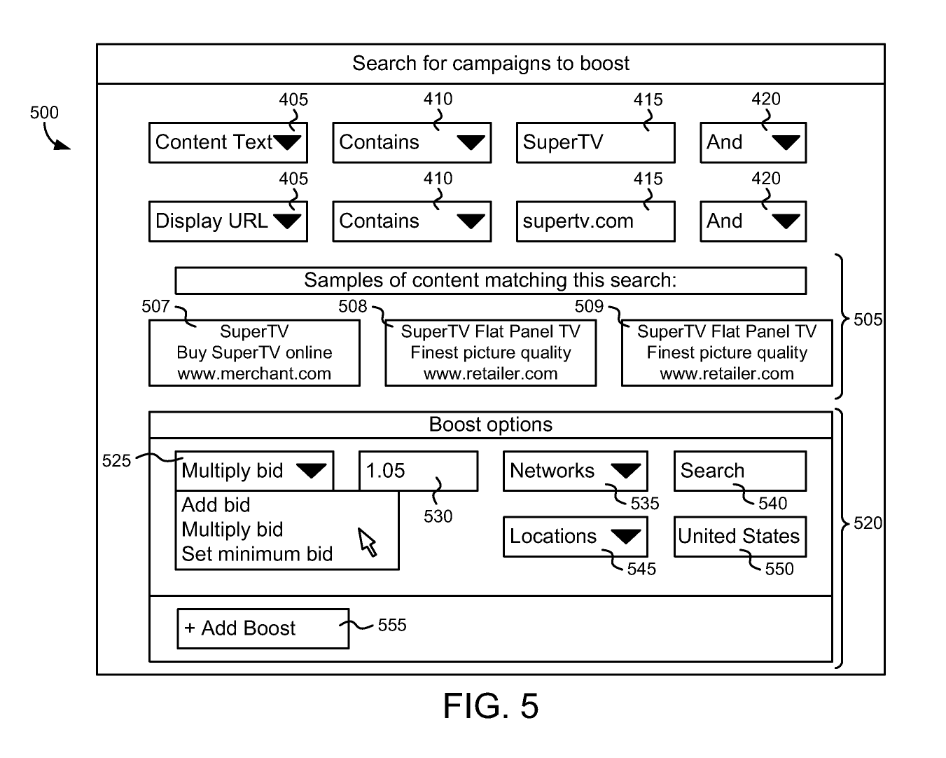

Referring now to FIGS. 4 and 5, display images 400 and 500 of an interface that may be used by boosters to select and apply supplemental bids in an online auction are shown according to illustrative implementations. Data configured to cause the interface of images 400 and 500 to be displayed on booster devices 107 may be transmitted from auction system 108 via network 102. The interface may be provided within any type of resource, such as a website or webpage accessible to booster devices 107, a dedicated boosting application partially or wholly resident on booster devices 107, or some other type of resource. The data may be formatted using any type of format that can be interpreted by booster devices 107 (e.g., HTML, Java, etc.).

Referring specifically to FIG. 4, the interface of image 400 includes one or more filter type selection fields 405 that allow a booster to specify one or more types of filters to apply when identifying initial bids to boost. The filter types may be configured to allow the initial bids to be filtered based on text of the content associated with the initial bids and/or text in the online address (e.g., URL) of a display resource upon which the content item would be displayed if the initial bid wins and/or of a destination resource to which the content item is configured to link when selected. In some implementations, boosters may be allowed to specify a minimum performance level for initial bids identified under the filter. For example, if a content item has been previously displayed, auction system 108 may have stored information regarding how many impressions, clicks, conversions, etc. that content item previously received, and those performance metrics may be used to filter which initial bids are captured in a proposed supplemental bid. In some implementations, boosters may be allowed to specify one or more verticals (e.g., subject matter areas) to which the content items associated with the initial bids should relate, such as medical devices or consumer electronic devices. In some implementations, the interface may allow the booster to provide one or more terms to be compared to all of the available filter fields, such that an initial bid will be captured by the filter if any of the fields are found to be relevant to the terms.

A filter qualification field 410 may be provided for one or more of the filter type selection fields 405 to allow boosters to specify how the selected filter type should be applied. For example, filter qualification field 410 may allow a booster to indicate that the filter should capture an initial bid if the field associated with the filter type contains a term, contains terms related to the provided terms, or does not contain the term. The term(s) associated with each filter element may be provided in a term entry field 415. A concatenation field 420 may be used to specify whether the selected filter element is an alternative to other elements (i.e., such that an initial bid will be captured by the filter if it meets either/any of the filter elements) or if both/all elements must be met for an initial bid to be captured by the filter. Additional filter elements may be added using an add filter element button 425.

Referring now to FIG. 5, a display image 500 of an interface that may appear after filter elements have been entered and submitted by a booster is shown according to an illustrative implementation. A sample results section 505 of the interface provides the booster with samples of the content items captured by the filters that would be boosted if the supplemental bid is approved by the booster. A first sample content item 507 is an advertisement to “Buy SuperTV online” that links to “www.merchant.com.” A second content item 508 and third content item 509 both are advertisements for a “SuperTV Flat Panel TV” that link to “www.retailer.com.” Sample content items may be displayed in sample results section 505 if disclosure of the content items to potential boosters has been allowed by the auction participants who submitted the initial bids associated with the content items. If the initial participants have indicated (e.g., in a settings interface) that the content items should not be disclosed to potential boosters, then auction system 108 may be configured to exclude those items from sample items provided in sample results section 505. In some implementations, additional or different information may be provided in sample results section 505, such as a number of content items captured by the applied filter and/or some aggregated information regarding the captured content items.

A boost options section 520 of the interface allows the booster to provide settings for the supplemental bid. A supplementing type field 525 allows the booster to specify what type of supplemental bid is being submitted (e.g., additive, multiplicative, supplement to minimum bid, etc.). A supplementing amount field 530 allows the booster to provide an amount by which the initial bid should be supplemented based on the supplementing type (e.g., an amount to add to the initial bid for an additive supplemental bid, an amount by which to multiply the initial bid for a multiplicative supplemental bid, a minimum bid to which the initial bid should be raised for a supplement to minimum bid type supplemental bid, etc.). A network selection field 535 allows the booster to select one or more resource networks (e.g., advertising networks) in which the initial bids should be supplemented. For example, different resource networks may be configured to publish the content items in different resources. The desired networks may be specified by the booster in network input field 540. A location selection field 545 may allow the booster to specify one or more geographic locations in which the initial bids should be supplemented. A location input field 550 may be used by the booster to provide the desired locations. In some implementations, boost options section 520 may provide some information to the booster about the supplemental bid before it is applied, such as a total cost of applying the supplemental bid, an average or median supplemental amount that will be applied, etc. Once the booster is satisfied with the selections, the supplemental bid may be approved and submitted to auction system 108. If the booster wishes to create further supplemental bids, the booster may do so by selecting a new supplemental bid button 555.

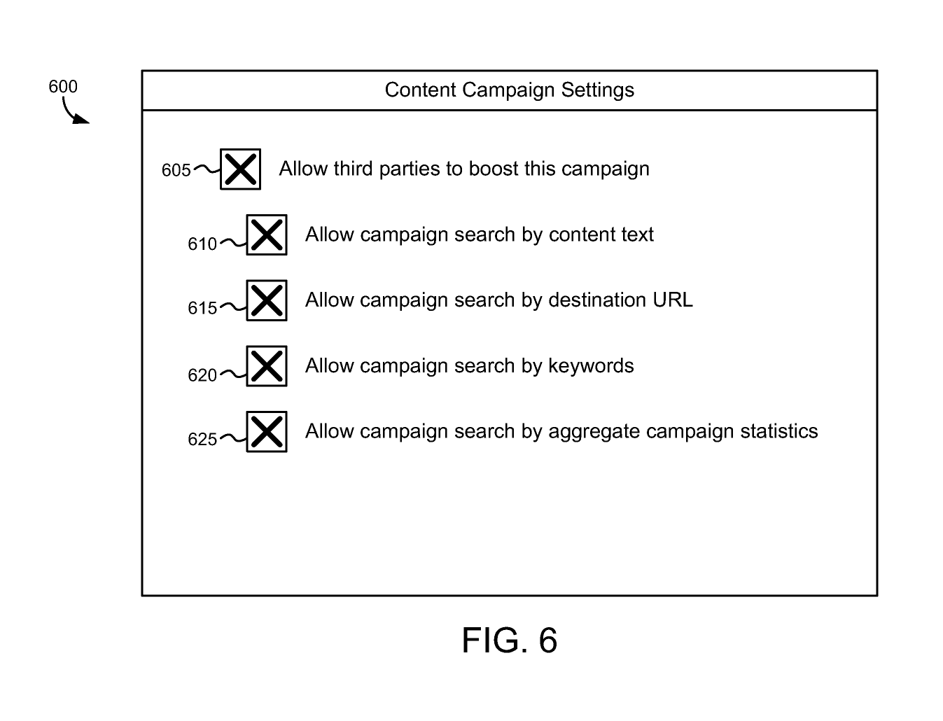

Referring now to FIG. 6, an example display image 600 of an interface that an auction participant may use to provide settings relating to how boosters can contribute to a content campaign is shown according to an illustrative implementation. The interface of image 600 may be used by an auction participant to indicate whether the auction participant wants to allow boosters to supplement the bids submitted by the auction participant and what, if any, information the auction participant is willing to share with potential boosters. A boosting enable field 605 allows the auction participant to enable or disable boosting by third parties. If boosting enable field 605 is disabled, auction system 108 may be configured to exclude initial bids submitted by the auction participant from bids identified during boosting filtering performed by boosters.

If boosting enable field 605 is enabled, one or more fields may be provided to the auction participant that may be used to specify the amount and type of information the auction participant is willing to share with potential boosters. Fields 610, 615, and 620 allow the auction participant to specify whether initial bids submitted by the auction participant can be filtered by boosters by content text, destination address, and terms associated with the bids, respectively. A field 625 determines whether initial bids submitted by the auction participant can be filtered based on aggregated statistics of the bids. In some implementations, the interface of image 600 may allow an auction participant to specify whether or not sample content items can be randomly selected and provided to potential boosters as samples of content items to which the supplemental bids would be applied. In some implementations, auction participants may be allowed to specify that none or all of the content items associated with their bids may be viewed by potential boosters. Allowing potential boosters the ability to view content items may increase the likelihood that the boosters would be willing to contribute to the content campaign. In some implementations, the interface may provide auction participants with multiple levels of options regarding whether potential boosters can access information regarding content items, one of which allows the participant to specify whether content items can be identified by filters applied by potential boosters (e.g., such that they may be included in a supplemental bid but the content may not be viewed by potential boosters) and another of which allows the participant to specify whether the actual content items themselves can be viewed by potential boosters.

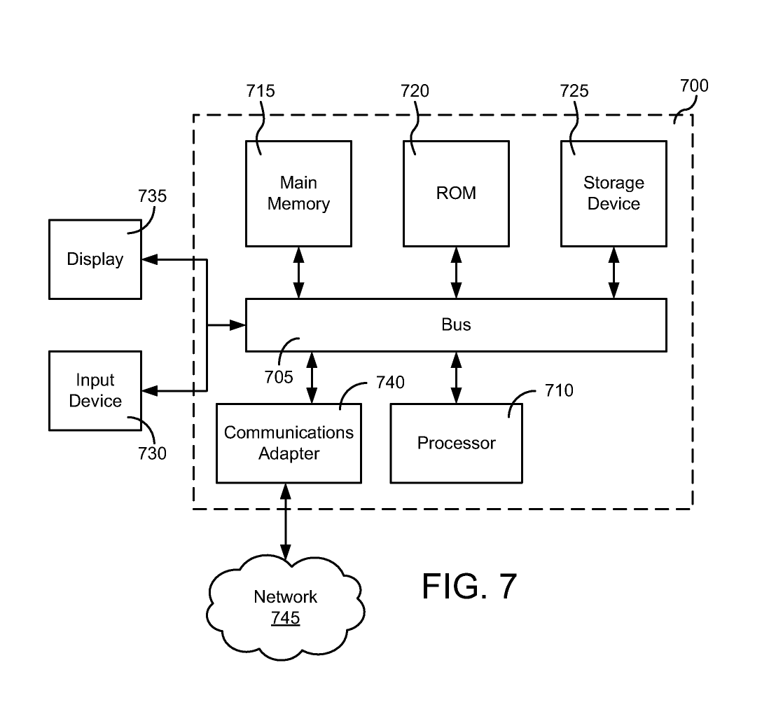

FIG. 7 illustrates a depiction of a computer system 700 that can be used, for example, to implement an illustrative user device 104, an illustrative content management system 108, an illustrative auction participant device 106, an illustrative booster device 107, and/or various other illustrative systems that may be used in the implementation of an environment in which online advertisements may be provided as described in the present disclosure. The computing system 700 includes a bus 705 or other communication component for communicating information and a processor 710 coupled to the bus 705 for processing information. The computing system 700 also includes main memory 715, such as a random access memory (RAM) or other dynamic storage device, coupled to the bus 705 for storing information, and instructions to be executed by the processor 710. Main memory 715 can also be used for storing position information, temporary variables, or other intermediate information during execution of instructions by the processor 710. The computing system 700 may further include a read only memory (ROM) 710 or other static storage device coupled to the bus 705 for storing static information and instructions for the processor 710. A storage device 725, such as a solid state device, magnetic disk or optical disk, is coupled to the bus 705 for persistently storing information and instructions.

The computing system 700 may be coupled via the bus 705 to a display 735, such as a liquid crystal display, or active matrix display, for displaying information to a user. An input device 730, such as a keyboard including alphanumeric and other keys, may be coupled to the bus 705 for communicating information, and command selections to the processor 710. In another implementation, the input device 730 has a touch screen display 735. The input device 730 can include a cursor control, such as a mouse, a trackball, or cursor direction keys, for communicating direction information and command selections to the processor 710 and for controlling cursor movement on the display 735.

In some implementations, the computing system 700 may include a communications adapter 740, such as a networking adapter. Communications adapter 740 may be coupled to bus 705 and may be configured to enable communications with a computing or communications network 745 and/or other computing systems. In various illustrative implementations, any type of networking configuration may be achieved using communications adapter 740, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. In alternative implementations, hard-wired circuitry may be used in place of or in combination with software instructions to implement illustrative implementations. Thus, implementations are not limited to any specific combination of hardware circuitry and software.

Although an example processing system has been described in FIG. 7, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, at a computerized auction system, a plurality of initial bids, each initial bid comprising a bid amount for a content item to be displayed, wherein the plurality of initial bids are received from one or more auction participants;
receiving, at the auction system, one or more supplemental bids, wherein each of the supplemental bids is associated with one or more of the plurality of initial bids and comprises a supplemental amount, wherein the one or more supplemental bids are received from one or more supplementing parties, wherein, for each supplemental bid, the supplementing party from whom the supplemental bid is received is a different party than the auction participant from whom the initial bid with which the supplemental bid is associated is received;
determining, at the auction system, for each of the initial bids, a combined bid amount based on the bid amount of the initial bid and the supplemental amount of any supplemental bids associated with the initial bid; and
determining, at the auction system, one or more of the plurality of initial bids to win the auction based on the combined bid amounts.

2. The method of claim 1, wherein the supplemental amount for each of the one or more supplemental bids comprises an amount to be added to the bid amount of the one or more initial bids with which the supplemental bid is associated, and wherein determining, for each of the initial bids, a combined bid amount comprises adding the supplemental amount of any supplemental bids associated with the initial bid to the bid amount of the initial bid.

3. The method of claim 1, wherein the supplemental amount for each of the one or more supplemental bids comprises a factor by which to multiply the bid amount of the one or more initial bids with which the supplemental bid is associated, and wherein determining, for each of the initial bids, a combined bid amount comprises multiplying the bid amount of the initial bid by the supplemental amount of any supplemental bids associated with the initial bid.

4. The method of claim 1, wherein the auction system is configured to not reveal information regarding at least one of the auction participants and the initial bids to the supplementing parties.

5. The method of claim 1, wherein the one or more supplemental bids are received from one or more supplementing parties, wherein the method further comprises:
receiving one or more terms from a supplementing party;
determining one or more initial bids associated with the one or more terms; and
providing result data to the supplementing party based on the one or more initial bids associated with the one or more terms,
wherein receiving one or more supplemental bids comprises receiving a supplemental bid associated with the determined one or more initial bids that are associated with the one or more terms.

6. The method of claim 5, wherein providing result data to the supplementing party comprises providing a number of determined initial bids associated with the one or more terms without providing the content items associated with the determined initial bids or information about parties from whom the auction system received the determined initial bids.

7. The method of claim 5, wherein determining one or more initial bids associated with the terms comprises:
searching contents of one or more landing resources associated with the one or more initial bids and determining whether the one or more landing resources are associated with the one or more terms, wherein each landing resource is a resource to which one or more of the content items is configured to link when selected by a user; and
for each landing resource determined to be associated with at least one of the one or more terms, determining the initial bid associated with the landing resource to be associated with the one or more terms.

8. The method of claim 5, wherein information about the initial bids that may be used to determine the initial bids associated with the one or more terms is restricted to information that could be used to target content items if they were displayed.

9. The method of claim 1, further comprising, for each initial bid determined to win the auction, determining payment amounts associated with the initial bid and any supplemental bids based on proportions of the bid amount of the initial bid and the supplemental amounts of any supplemental bids to the combined bid amount for the initial bid.

10. A system comprising:
at least one computing device operably coupled to at least one memory and configured to:
receive a plurality of initial bids, each initial bid comprising a bid amount for a content item to be displayed, wherein the plurality of initial bids are received from one or more auction participants;
receive one or more supplemental bids, wherein each of the supplemental bids is associated with one or more of the plurality of initial bids and comprises a supplemental amount, wherein the one or more supplemental bids are received from one or more supplementing parties, wherein, for each supplemental bid, the supplementing party from whom the supplemental bid is received is a different party than the auction participant from whom the initial bid with which the supplemental bid is associated is received;
determine, for each of the initial bids, a combined bid amount based on the bid amount of the initial bid and the supplemental amount of any supplemental bids associated with the initial bid; and
determine one or more of the plurality of initial bids to win the auction based on the combined bid amounts.

11. The system of claim 10, wherein the supplemental amount for each of the one or more supplemental bids comprises an amount to be added to the bid amount of the one or more initial bids with which the supplemental bid is associated, and wherein the at least one computing device is configured to determine the combined bid amount by adding the supplemental amount of any supplemental bids associated with the initial bid to the bid amount of the initial bid.

12. The system of claim 10, wherein the supplemental amount for each of the one or more supplemental bids comprises a factor by which to multiply the bid amount of the one or more initial bids with which the supplemental bid is associated, and wherein the at least one computing device is configured to determine the combined bid amount by multiplying the bid amount of the initial bid by the supplemental amount of any supplemental bids associated with the initial bid.

13. The system of claim 10, wherein the at least one computing device is configured to not reveal information regarding at least one of the auction participants and the initial bids to the supplementing parties.

14. The system of claim 10, wherein the one or more supplemental bids are received from one or more supplementing parties, wherein the at least one computing device is configured to:
receive one or more terms from a supplementing party;
determine one or more initial bids associated with the one or more terms;
provide result data to the supplementing party based on the one or more initial bids associated with the one or more terms; and
receive a supplemental bid associated with the determined one or more initial bids that are associated with the one or more terms.

15. The system of claim 14, wherein the at least one computing device is configured to provide result data including a number of determined initial bids associated with the one or more terms without providing the content items associated with the determined initial bids or information about parties from whom the auction system received the determined initial bids.

16. The system of claim 14, wherein the at least one computing device is configured to determine the one or more initial bids associated with the terms by:
searching contents of one or more landing resources associated with the one or more initial bids and determining whether the one or more landing resources are associated with the one or more terms, wherein each landing resource is a resource to which one or more of the content items is configured to link when selected by a user; and
for each landing resource determined to be associated with at least one of the one or more terms, determining the initial bid associated with the landing resource to be associated with the one or more terms.

17. The system of claim 14, wherein the at least one computing device is configured to restrict information about the initial bids that may be used to determine the initial bids associated with the one or more terms to information that could be used to target content items if they were displayed.

18. A computer-readable storage medium having instructions stored thereon that, when executed by a processor, cause the processor to perform operations comprising:
receiving a plurality of initial bids, each initial bid comprising a bid amount for a content item to be displayed, wherein the plurality of initial bids are received from one or more auction participants;
receiving one or more supplemental bids, wherein each of the supplemental bids is associated with one or more of the plurality of initial bids and comprises a supplemental amount, wherein the one or more supplemental bids are received from one or more supplementing parties, wherein, for each supplemental bid, the supplementing party from whom the supplemental bid is received is a different party than the auction participant from whom the initial bid with which the supplemental bid is associated is received;
determining, for each of the initial bids, a combined bid amount based on the bid amount of the initial bid and the supplemental amount of any supplemental bids associated with the initial bid; and
determining one or more of the plurality of initial bids to win the auction based on the combined bid amounts.

19. The computer-readable storage medium of claim 18, wherein the supplemental amount for each of the one or more supplemental bids comprises an amount to be added to the bid amount of the one or more initial bids with which the supplemental bid is associated, and wherein determining, for each of the initial bids, a combined bid amount comprises adding the supplemental amount of any supplemental bids associated with the initial bid to the bid amount of the initial bid.

20. The computer-readable storage medium of claim 18, wherein the supplemental amount for each of the one or more supplemental bids comprises a factor by which to multiply the bid amount of the one or more initial bids with which the supplemental bid is associated, and wherein determining, for each of the initial bids, a combined bid amount comprises multiplying the bid amount of the initial bid by the supplemental amount of any supplemental bids associated with the initial bid.

21. The computer-readable storage medium of claim 18, wherein information revealed to the supplementing parties does not include information regarding at least one of the auction participants and the initial bids.

22. The computer-readable storage medium of claim 18, wherein the one or more supplemental bids are received from one or more supplementing parties, wherein the operations further comprise:
receiving one or more terms from a supplementing party;
determining one or more initial bids associated with the one or more terms; and
providing result data to the supplementing party based on the one or more initial bids associated with the one or more terms,
wherein receiving one or more supplemental bids comprises receiving a supplemental bid associated with the determined one or more initial bids that are associated with the one or more terms.

23. The computer-readable storage medium of claim 22, wherein providing result data to the supplementing party comprises providing a number of determined initial bids associated with the one or more terms without providing the content items associated with the determined initial bids or information about parties from whom the auction system received the determined initial bids.
